(19) United States
(12) Patent Application Publication
(10) Pub. No.: US 2009/0308539 A1
(43) Pub. Date: Dec. 17, 2009

(54) FILTER MANUFACTURING APPARATUS WITH WELDING

(75) Inventor: Mu-Yeal Son, Gwangju-si (KR)

Correspondence Address: EDWARDS ANGELL PALMER & DODGE LLP, P.O. BOX 55874, BOSTON, MA, 02205, US

(73) Assignee: INNSAN CO., LTD, YONGIN (KR)

(21) Appl. No.: 11/914,133

(22) PCT Filed: Aug. 28, 2007
(86) PCT No.: PCT/KR07/04125

§ 371 Date: Nov. 10, 2007

(30) Foreign Application Priority Data
Oct. 13, 2006 (KR) 10-2006-0099862

(51) Int. Cl. B29C 65/02

(52) U.S. Cl. 156/499

(57) ABSTRACT

Provided are a filter manufacturing apparatus for fabricating a lower cap with an open upper portion and a lower cap welding portion therein, an upper cap with an open upper portion and an upper cap welding portion therein, and a non-woven fabric of a filter medium between the lower cap and the upper cap, the apparatus comprising a lower cap heating unit for melting only the lower cap welding portion (352) by mounting the lower cap (350) and heating a hot wire connected to an external power supply, a lower cap pressing unit for pressing the non-woven fabric (370) on the lower cap welding portion (352), an upper cap heating unit for melting only the upper cap welding portion (362) by mounting the upper cap (360) and heating a hot wire connected to an external power supply, and an upper cap pressing unit for pressing the non-woven fabric (370) bonded to the lower cap (350) by the lower cap pressing unit on the upper cap welding portion (362).

### TECHNICAL FIELD

The present invention relates to an apparatus for manufacturing a filter for use in a vehicle. More particularly, it relates to a filter manufacturing apparatus for a vehicle, which can rapidly and easily manufacture an air tight and strong filter by melting only an inner portion of a plurality of upper caps and lower caps of the filter.

### BACKGROUND ART

A vehicular fuel filter generally plays an important role in improving fuel efficiency, reducing air pollutants and protecting parts such as engine components by supplying clean fuel from which impurities have been filtered.

The filter requires air tightness since it filters impurities in fuel. The filter also requires strength and durability to prevent deformation due to vibration or shock while vehicle's running.

A vehicular engine oil filter includes a filtering unit having the same structure as that of the fuel filter. The filtering unit is mounted inside a metal case of the engine oil filter connected to the vehicle. The oil filter may be replaced with a new one when the engine oil is changed, for example, about every 10,000 kilometers.

Typically, a fuel filter or an oil filter includes a filter medium, an upper cap and a lower cap. The filter medium is formed of non-woven fabric. The upper and lower caps are connected to the non-woven fabric by welding. Generally, an apparatus for manufacturing such fuel or oil filter includes a clamp securing the non-woven fabric, a flaming unit heating the upper and lower caps, and a pressing unit pressing the non-woven fabric on the upper and lower caps.

However, the surfaces of the upper and lower caps may be melted by flame generated from the flaming unit in the conventional filter manufacturing apparatus. Accordingly, the surfaces of the upper and lower caps may be hardened or deformed by the heat of the flame. That is, the bonding between the upper or lower cap and the non-woven fabric may not be sufficiently strong and airtight.

### DISCLOSURE

### Technical Problem

Accordingly, the present invention is directed to a filter manufacturing apparatus that substantially obviates one or more of the above-described problems associated with prior art.

An object of the present invention is to provide a filter manufacturing apparatus which can rapidly and easily manufacture an air tight and strong filter by melting only inner portions of a plurality of upper caps and lower caps to prevent deformations of the caps and tightly press a non-woven fabric on the caps.

### Technical Solution

To achieve these and other advantages and in accordance with the purpose of the present invention, as embodied and broadly described, there is provided a filter manufacturing apparatus for fabricating a lower cap with an open upper portion and a lower cap welding portion therein, an upper cap with an open upper portion and an upper cap welding portion therein, and a non-woven fabric of a filter medium between the lower cap and the upper cap, the apparatus including: a lower cap heating unit for melting only the lower cap welding portion (352) by mounting the lower cap (350) and heating a hot wire connected to an external power supply; a lower cap pressing unit for pressing the non-woven fabric (370) on the lower cap welding portion (352); an upper cap heating unit for melting only the upper cap welding portion (362) by mounting the upper cap (360) and heating a hot wire connected to an external power supply; and an upper cap pressing unit for pressing the non-woven fabric (370) bonded to the lower cap (350) by the lower cap pressing unit on the upper cap welding portion (362).

In a preferred embodiment, the filter manufacturing apparatus may further include: a support plate (300) for supporting the lower and upper cap pressing units disposed on a front surface of the support plate (300) and the lower and upper cap heating units on a back surface of the support plate (300); rectangular mounting supporters (180, 182, 280, 282) respectively positioned under the lower cap pressing and heating units, and the upper cap pressing and heating units; lower and upper cap mounting portions (190, 192, 290, 292) mounted on the mounting supporters (180, 182, 280, 282); a first connection bar (184) connecting the mounting supporter (180) to the mounting supporter (182); a second connection bar (284) connecting the mounting supporter (280) to the mounting supporter (282); and moving cylinders (186, 286) configured to be able to move the lower and upper cap mounting portions to the lower cap pressing and heating units and the upper cap pressing and heating units, the first and second connection bars being connected to a piston rod.

In another preferred embodiment, the filter manufacturing apparatus may further include a lower cap fixing plate (194) with a circular plate shape and a plurality of protrusions at a side surface mounted on the lower cap mounting portions (190, 192), so that the lower cap fixing plate (194) may be inserted into a mounting hole (354) of the lower cap (350).

The lower and upper cap heating units may, preferably, include: a heating unit frame (120) mounted on the supporting plate (300) in a rectangular shape; a heating unit cylinders (100 and 200) mounted on an upper frame of the heating unit frame (120) at intervals of a predetermined distance; movement limit plates (106, 206) with a plate shape respectively mounted on the top side of piston rods (100, 200) which move up and down in accordance with a movement of the heating unit cylinders (100, 200); guide rods (104, 105, 204, 205) mounted on both sides of the heating unit cylinders (100, 200), vertically connected to the movement limit plates (106, 206) at one side and penetrated into the heating unit frame (120) at the other side; heating movement plates (174, 274) with a plate shape connected to the piston rods (102, 202) and the guide rods (104, 105, 204, 205); heating plates (170, 172, 270, 272) respectively disposed at a lower side of the heating movement plates (174, 274) with a hot wire generating heat of a predetermined temperature by receiving power from an external source; and melting plates (171, 173, 271, 273) respectively mounted on the lower surface of the heating plates (170, 172, 270, 272).

The melting plates (171, 173, 271, 273) may, suitably, have a cylindrical shape with an open lower portion, and a side surface with a predetermined height so as to melt only the lower and upper cap welding portions (352, 362), and be chamfered along lower edge of the side thereof.

In a further preferred embodiment, the filter manufacturing apparatus may further include adhesion protectors (320, 322) with a tuning fork shape disposed in the upper cap heating unit to prevent the upper cap (360) from moving together with melting plates (271, 273) when the melting plates (271, 273) move upwardly after melting the upper cap (360).

The lower cap pressing unit may, preferably, include a lower cap pressing frame (130); a pressing unit cylinder (140) mounted on the top side of the lower cap pressing frame (130); a pressing movement plate (162) mounted on the top side of the lower cap pressing frame (130) connected to a piston rod of the pressing unit cylinder (140) and configured to be able to move up and down inside of the lower cap pressing frame (130); pressing limit plates (150, 152) mounted on a plurality of cylinders at the one end, the plurality of the cylinders being mounted on the top surface of the pressing movement plate (162) at the other end and penetrated into the top side of the lower cap pressing frame (130), so that the pressing movement (162) may move up and down in the lower cap pressing frame (130); and pressing plates (160, 162) mounted on the lower surface of the pressing movement plate (162) to press the non-woven fabric (370) and the lower cap (350) on the lower cap mounting portions (190, 192).

The upper cap pressing unit may, preferably, include: an upper cap pressing frame (230); a pressing unit cylinder (240) mounted on the top side of the upper cap pressing frame (230); a pressing movement plate (262) mounted on the top side of the upper cap pressing frame (230) connected to a piston rod of the pressing unit cylinder (240) and configured to be able to move up and down inside of the upper cap pressing frame (230); pressing limit plates (250, 252) mounted on a plurality of cylinders at the one end, the plurality of the cylinders being mounted on the top surface of the pressing movement plate (262) at the other end and penetrated into the top side of the upper cap pressing frame (230), so that the pressing movement (262) may move up and down in the upper cap pressing frame (230); and pressing plates (260, 262) mounted on the lower surface of the pressing movement plate (262) to press the non-woven fabric (370) and the upper cap (360) on the upper cap mounting portions (290, 292).

Suitably, the filter manufacturing apparatus may further include a control panel (340). The control panel (340) may include an operation lamp (341) indicating an operation state, a display unit (342) displaying pressure and temperature of the cylinders, a timer (343) for setting up an operation time, a counter (344) counting a product, a manual switch (346) handling each unit, and a power switch (345) for supplying power from an external source.

On the other hand, two operation switches (310, 312) may be disposed on front surface of the supporting plate (300) to operate the lower and upper heating units and the lower and upper pressing units. For an operator's safety, the operation switches (310, 312) are configured to be operated only when the both operation switches (310, 312) are operated at the same time.

### BRIEF DESCRIPTION OF DRAWINGS

FIG. 1 is a schematic view of a filter manufacturing apparatus with welding according to an embodiment of the present invention.

FIG. 2 is a longitudinal sectional view of an upper cap welding unit in a filter manufacturing apparatus with welding according to an embodiment of the present invention.

FIG. 3 is a plan sectional view of a welding unit in a filter manufacturing apparatus with welding according to an embodiment of the present invention.

FIG. 4 is a cross sectional view of a welding unit in a filter manufacturing apparatus with welding according to an embodiment of the present invention.

FIG. 5 is a cross sectional view of a pressing unit in a filter manufacturing apparatus with welding according to an embodiment of the present invention.

FIG. 6 is a schematic diagram of a control plate in a filter manufacturing apparatus with welding according to an embodiment of the present invention.

FIGS. 7 and 8 are perspective views of a filter manufactured by an embodiment of the present invention.

FIGS. 9 and 10 are exploded views of a filter before and after being welded according to an embodiment of the present invention.

FIGS. 11 and 12 are perspective views of upper and lower caps of a filter manufactured by an embodiment of the present invention.

FIGS. 13 to 16 are magnified views of a welding portion of a filter manufactured by an embodiment of the present invention.

FIG. 17 is a graph illustrating strength of a welding portion in a filter according to an embodiment of the present invention.

FIGS. 18 and 19 are diagrams of a welding portion according to an embodiment of the present invention.

### BEST MODE FOR INVENTION

Hereinafter, preferred embodiments of the present invention will be described in detail with respect to accompanying drawings.

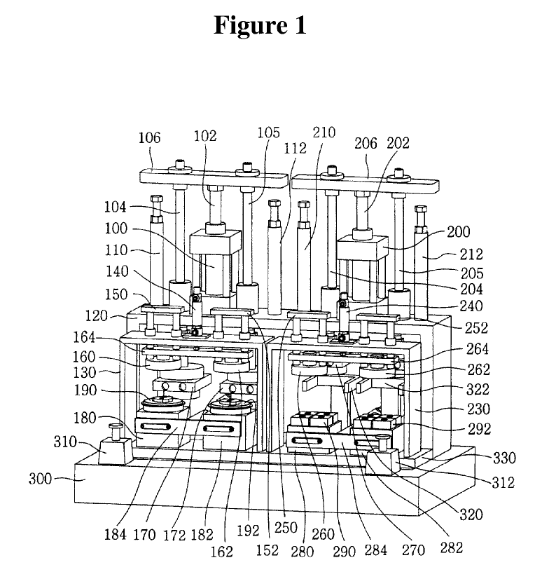

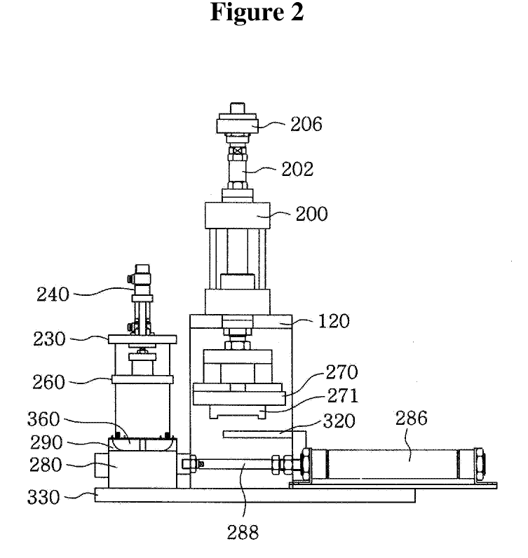

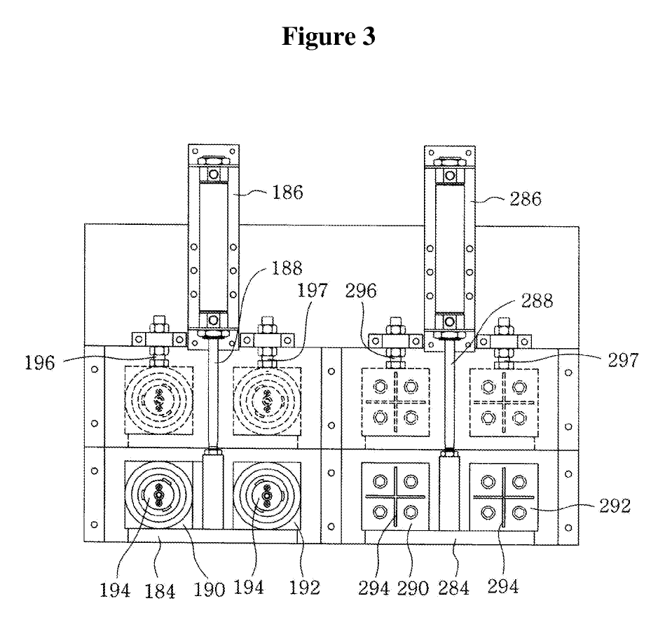

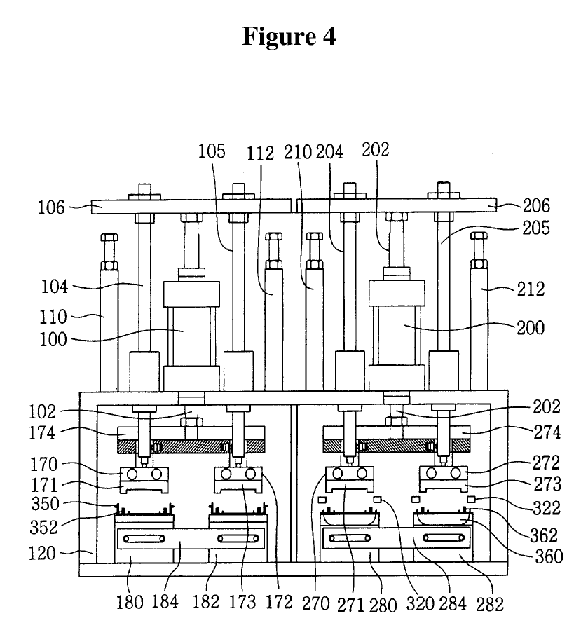

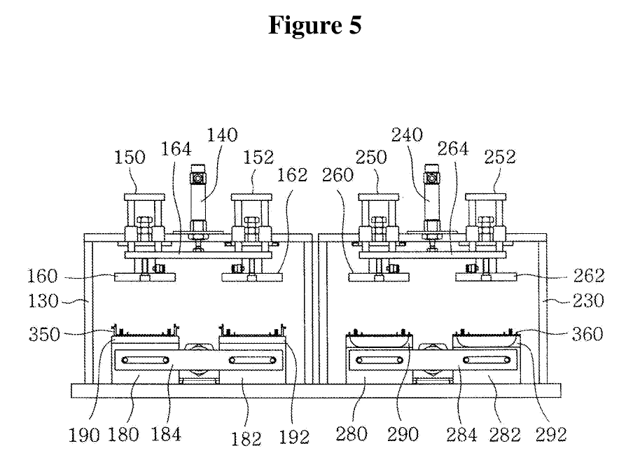

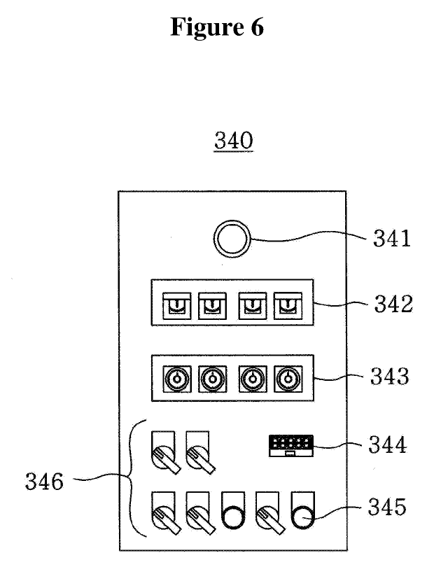

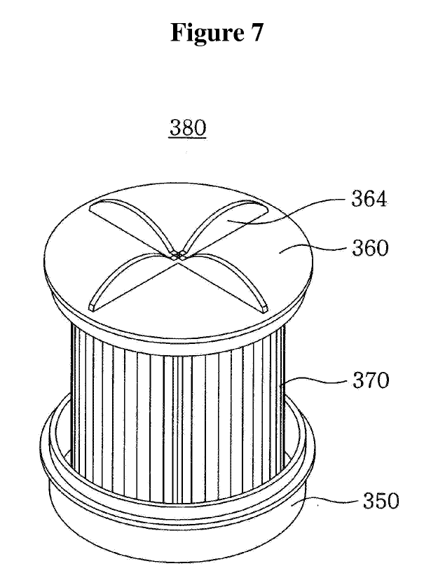

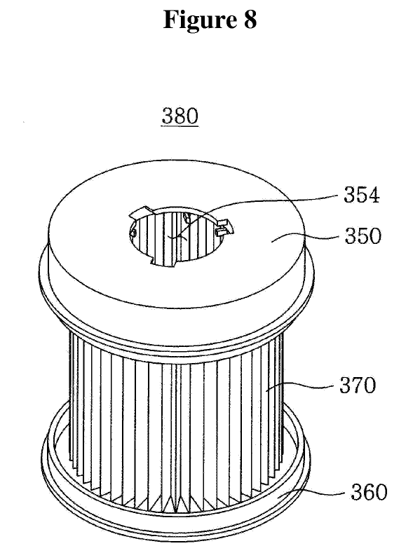

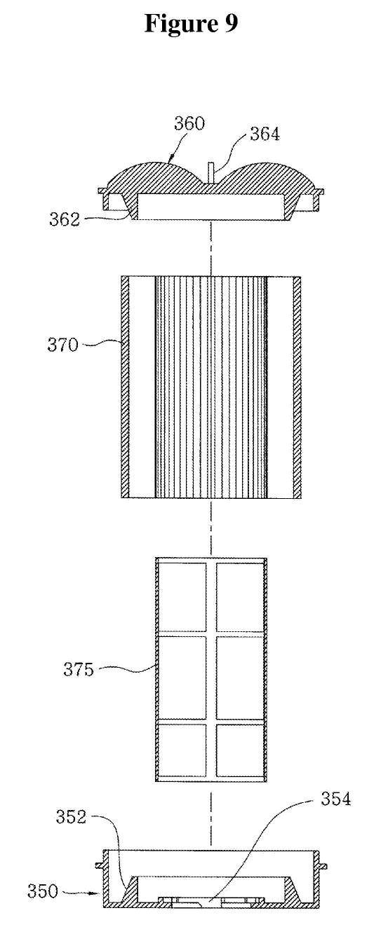

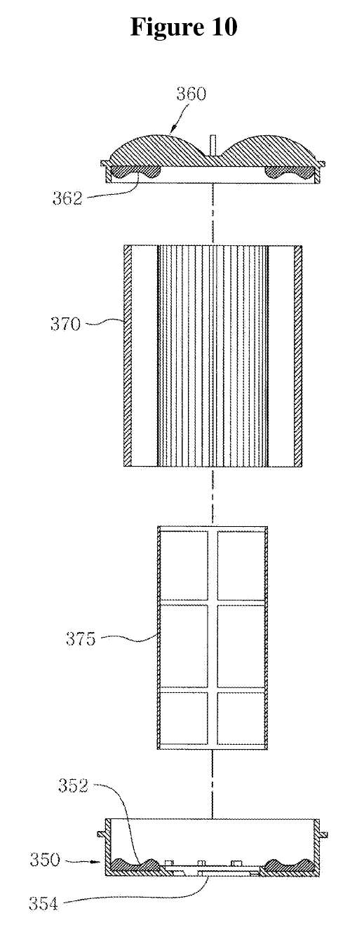

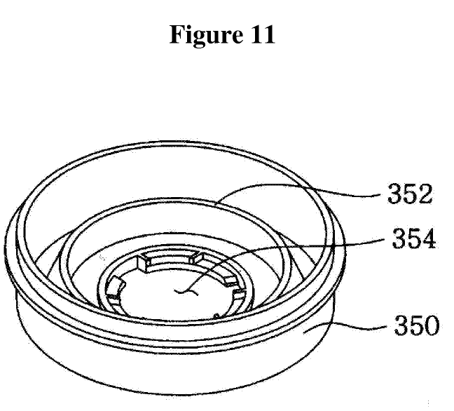

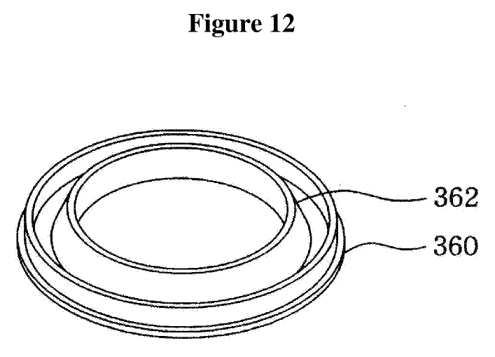

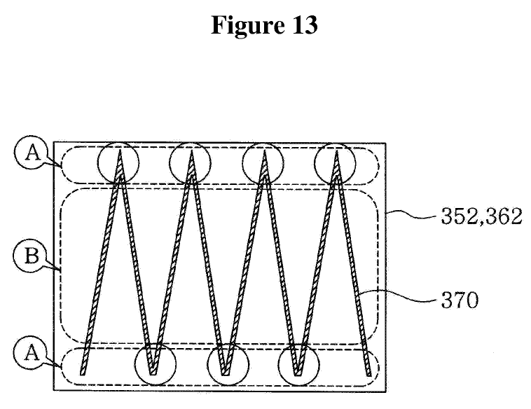

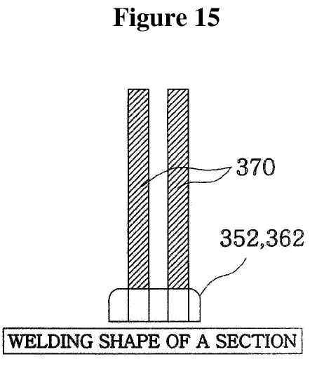

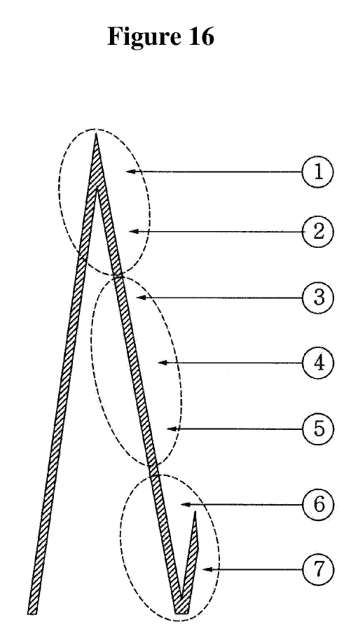

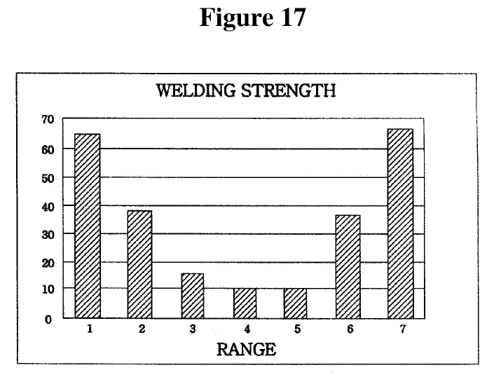

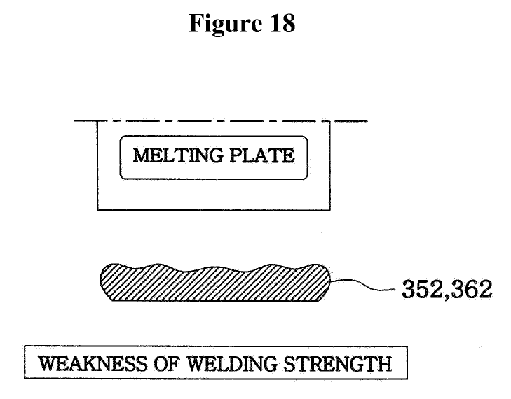

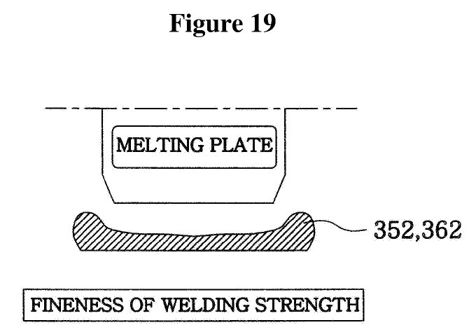

FIG. 1 is a schematic view of a filter manufacturing apparatus with welding according to an embodiment of the present invention. FIG. 2 is a longitudinal sectional view of an upper cap welding unit in a filter manufacturing apparatus with welding according to an embodiment of the present invention. FIG. 3 is a plan sectional view of a welding unit in a filter manufacturing apparatus with welding according to an embodiment of the present invention. FIG. 4 is a cross sectional view of a welding unit in a filter manufacturing apparatus with welding according to an embodiment of the present invention. FIG. 5 is a cross sectional view of a pressing unit in a filter manufacturing apparatus with welding according to an embodiment of the present invention. FIG. 6 is a schematic diagram of a control plate in a filter manufacturing apparatus with welding according to an embodiment of the present invention. FIGS. 7 and 8 are perspective views of a filter manufactured by an embodiment of the present invention. FIGS. 9 and 10 are exploded views of a filter before and after being welded according to an embodiment of the present invention. FIGS. 11 and 12 are perspective views of upper and lower caps of a filter manufactured by an embodiment of the present invention. FIGS. 13 to 16 are magnified views of a welding portion of a filter manufactured by an embodiment of the present invention. FIG. 17 is a graph illustrating strength of a welding portion in a filter according to an embodiment of the present invention. FIGS. 18 and 19 are diagrams of a welding portion according to an embodiment of the present invention.

Referring to FIGS. 1 to 6, a filter manufacturing apparatus according to a preferred embodiment of the present invention includes a supporting plate, a lower cap heating unit, a lower cap pressing unit, an upper cap heating unit, an upper cap pressing unit, and a controlling unit.

The supporting plate 300, preferably, has a rectangular shape. The lower cap heating unit melts a lower cap of a filter on the supporting plate 300. The lower cap pressing unit connects a non-woven fabric to the lower cap melted at the lower cap heating unit. The upper cap heating unit melts an upper cap of the filter. The upper cap pressing unit connects the lower cap connected with the non-woven fabric to the melted upper cap. The controlling unit controls all the units.

Referring to FIG. 13, a lower cap 350 has a cup shape with an open upper portion. The lower cap 350 has a mounting hole 354 penetrating through the center thereof. Also, a lower cap welding portion 352 is protruded to a predetermined height at a predetermined distance between the mounting hole 354 and a side surface of the lower cap 350. At this point, a plurality of grooves are disposed along with the inner perimeter of the mounting hole 354 to extend the minor diameter of the mounting hole 354.

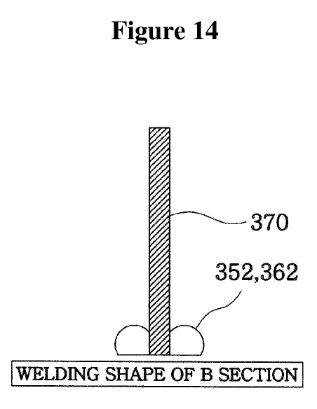

Referring to FIG. 14, an upper cap 360 has a cap shape with an open lower portion. The side surface of the upper cap 360 is protruded to a predetermined height. Also, an upper cap welding portion 362 protruded to a predetermined height is disposed inside of the upper cap 360. A protruded wing 364 (shown in FIG. 7) with a cross shape is upwardly disposed on the upper surface of the upper cap 360.

Referring to FIGS. 9 and 10, lower and upper caps 350 and 360 are respectively connected to lower and upper portions of a non-woven fabric 370 used as a filter medium to form a filter. A non-woven fabric frame 375 with open upper and lower surfaces and lateral lattice holes may be further included in the non-woven fabric 370 to reinforce strength of the non-woven fabric 370. As shown in FIG. 10, the filter has a melted upper welding portion 362 and a melted lower cap welding portion 352. Melting and pressing processes are performed by a filter manufacturing apparatus according to the present invention to fabricate a filter 380 illustrated in FIGS. 7 and 8. FIG. 7 shows the filter 380 in an upright position with an upper cap 360 at the top, and FIG. 8 show the filter 380 in an upright position with a lower cap 350 at the top.

The filter manufacturing apparatus is supported by a supporting plate 300 which is, preferably, a steel plate with a predetermined height. That is, the lower and upper cap pressing units are located at the front side, and the lower and upper cap heating units are adjacently located at the behind of the pressing units.

Referring FIG. 4, with regard to the lower and upper cap heating units, a heating unit frame 120 with a rectangular shape is mounted on the supporting plate 300. A heating unit cylinders 100 and 200 for melting and pressing the lower and upper caps 350 and 360 are mounted on the heating unit frame 120. Also, plate-shaped movement limit plates 106 and 206 are respectively mounted on the top side of piston rods 102 and 202 which move up and down in accordance with a movement of the heating unit cylinders 100 and 200. Guide rods 104, 105, 204 and 205 are mounted on the both sides of the heating unit cylinders 100 and 200. The guide rods 104, 105, 204 and 205 are parallel with the heating unit cylinders 100 and 200, vertically connected to the movement limit plates 106 and 206 at one side and penetrated into the heating unit frame 120 at the other side. At this point, the guide rods 104, 105, 204 and 205 may move up and down at the same time when the piston rods 102 and 202 of the heating unit cylinders 100 and 200 move up and down through the heating unit frame 120. Plate-shaped heating movement plates 174 and 274 are connected to the piston rods 102 and 202, and the guide rods 104, 105, 204 and 205 in the heating unit frame 120.

The heating movement plates 174 and 274 move up and down in accordance with movement of the heating unit cylinders 100 and 200. A downward movement of the heating unit cylinders 100 and 200 is limited to a predetermined distance by movement limit rods 110, 112, 210 and 212 which are fixed parallel with the guide rods 104, 105, 204 and 205 at the heat unit frame 120, thereby preventing an incident. At this point, bolts and nuts may be mounted on the top of the movement limit rods 110, 112, 210 and 212 to adjust a vertical movement distance of the guide rods 104, 105, 204 and 205.

Heating plates 170, 172, 270 and 272 are respectively disposed at a lower side of the heating movement plates 174 and 274 in the lower and upper cap heating units. The heating plates include a hot wire generating heat of a predetermined temperature by receiving power from an external source. Melting plates 171, 173, 271 and 273 are mounted on the lower surface of the heating plates 170, 172, 270 and 272.

The melting plates 171, 173, 271 and 273 have a cylindrical shape with an open lower portion, and a side surface with a predetermined height so as to melt only a lower and upper cap welding portions 352 and 362. The melting plates 171, 173, 271 and 273 may be chamfered along a lower edge of the rectangular section as illustrated in FIG. 19.

Referring to FIGS. 2 to 4, lower cap mounting portions 190 and 192 and upper cap mounting portions 290 and 292 for safely mounting the lower and upper caps 350 and 360 melted by the melting plates 171, 173, 271 and 273 are respectively mounted on rectangular mounting supporters 180, 182, 280 and 282.

Referring to FIG. 5, the lower cap pressing unit includes a lower cap pressing frame 130, a pressing unit cylinder 140, a pressing movement plate 162, pressing limit plates 150 and 152, and pressing plates 160 and 162. The lower cap pressing frame 130 has, preferably, a rectangular shape. The pressing unit cylinder 140 is mounted on the top side of the lower cap pressing frame 130. The pressing movement plate 162 is connected to a piston rod of the pressing unit cylinder 140, and moves up and down inside of the lower cap pressing frame 130. The pressing limit plates 150 and 152 are mounted on a plurality of cylinders at the one end, a plurality of the cylinders being mounted on the top surface of the pressing movement plate 162 at the other end. The cylinders are penetrated into the top side of the lower cap pressing frame 130, so that the pressing movement 162 may move up and down in the lower cap pressing frame 130. The pressing plates 160 and 162 are mounted on the lower surface of the pressing movement plate 162 to press the non-woven fabric 370 and the lower cap 350 mounted on the lower cap mounting portions 190 and 192.

The upper cap pressing unit includes an upper cap pressing frame 230, a pressing unit cylinder 240, a pressing movement plate 262, pressing limit plates 250 and 252, and pressing plates 260 and 262. The upper cap pressing frame 230 has a rectangular shape. The pressing unit cylinder 240 is mounted on the top side of the upper cap pressing frame 230. The pressing movement plate 262 is connected to a piston rod of the pressing unit cylinder 240, and moves up and down inside of the upper cap pressing frame 230. The pressing limit plates 250 and 252 are mounted on a plurality of cylinders at the one end, a plurality of the cylinders being mounted on the top surface of the pressing movement plate 262 at the other end. The cylinders is penetrated into the top side of the upper cap pressing frame 230, so that the pressing movement 262 may move up and down in the upper cap pressing frame 230. The pressing plates 260 and 262 are mounted on the lower surface of the pressing movement plate 262 to press the non-woven fabric 370 and the upper cap 360 mounted on the upper cap mounting portions 290 and 292.

The mounting supporters 180, 182, 280 and 282 may slide back and forth on a base plate 330 (shown in FIG. 2) in a direction orthogonal to motion of the heating unit cylinders 100 and 200. That is, the mounting supporters 180 and 182 on the lower cap heating unit and the lower cap pressing unit are connected to each other by a connection bar 184. Also the mounting supporters 180 and 182 are moved from a position under the heating plates 170 and 172 of the lower cap heating unit to a position under the pressing plates 160 and 162 by an operation of a moving cylinder 186. Similarly, the mounting supporters 280 and 282 on the upper cap heating unit and the upper cap pressing unit are connected to each other by a connection bar 284. Also the mounting supporters 280 and 282 are moved from a position under the heating plates 270 and 272 of the upper cap heating unit to a position under the pressing plates 260 and 262 by an operation of a moving cylinder 286.

The lower cap mounting portions 190 and 192 are mounted on mounting supporters 180 and 182 on the lower cap heating unit and the lower cap pressing unit. A lower cap fixing plate 194 is mounted on the lower cap mounting portions 190 and 192. A plurality of protrusions are formed at the edge of the lower cap fixing plate 194, so that the lower cap fixing plate 194 can be inserted into a mounting hole 354 of the lower cap 350. Accordingly, the lower cap fixing plate 194 is inserted into the mounting hole 354 of the lower cap 350 and rotated in the mounting hole 354, so that the lower cap 350 may be tightly mounted on the lower cap mounting portions 190 and 192.

Also, the upper cap mounting portions 290 and 292 are mounted on mounting supporters 280 and 282 on the upper cap heating unit and the upper cap pressing unit. A cross shaped upper cap groove 294 is formed on the upper cap mounting portions 290 and 292, so that a protruded wing 364 of the upper cap 360 may be inserted into the upper cap groove 294. On the other hand, adhesion protectors 320 and 322 having a tuning fork shape are disposed in the upper cap heating unit. The adhesion protectors 320 and 322 prevent the upper cap 360 from moving together with melting plates 271 and 273 when the melting plates 271 and 273 move upwardly after melting the upper cap 360.

Referring to FIG. 6, a control panel 340 includes an operation lamp 341 indicating an operation state, a display unit 342 displaying pressure and temperature of the cylinders, a timer 343 for setting up an operation time, a counter 344 counting a product, a manual switch 346 handling each unit, and a power switch 345 for supplying power from an external source. On the other hand, two operation switches 310 and 312 are mounted on front surface of the supporting plate 300. For an operator's safety, the operation switches 310 and 312 are configured to be operated only when the both operation switches 310 and 312 are operated at the same time.

First, the timer 343 of the control panel 340 sets up an appropriate operation time.

Next, the heating plates 170, 172, 270 and 272 are heated to a predetermined temperature for melting the lower and upper caps 350 and 360. Then, two lower caps 350 are mounted on the lower cap mounting portions 190 and 192, and two upper caps 360 are mounted on the upper cap mounting portions 290 and 292. At this point, the lower cap fixing plates 194 of the lower cap mounting portions 190 and 192 are inserted into the mounting hole 354 of the lower cap 350 and rotated in the mounting hole 354 of the lower cap 350.

Next, the both operation switches 310 and 312 are switched at the same time to operate the moving cylinders 186 and 286. The moving cylinders 186 and 286 move the mounting supporters 180, 182, 280 and 282 to positions under of the heating plates 170, 172, 270 and 272.

When the mounting supporters 180, 182, 280 and 282 are moved the positions under the heating plates 170, 172, 270 and 272, the heating unit cylinders 100 and 200 are downwardly moved, thereby moving the heating movement plates 174 and 274 downwardly. Since the melting plates 171, 173, 271 and 273 are in a condition of being enough heated by the heating plates 170, 172, 270 and 272, the lower cap welding portion 352 and upper cap welding portion 362 are enough melted. At this point, the upper cap welding portion 362 is operated after a predetermined time has elapsed following the operation of the lower cap welding portion 352.

Next, the heating unit cylinders 100 and 200 are operated to move the heating movement plates 174 and 274 upwardly. The moving cylinders 186 and 286 are operated to move the mounting supports 180, 182, 280 and 282 to positions under the pressing plates 160, 162, 260 and 262. When the mounting supports 180, 182, 280 and 282 are positioned under the pressing supports 180, 182, 280 and 282, an apparatus operator mounts a now-woven fabric and a now-woven fabric frame 375 on the lower cap welding portion 352 of the lower cap 350. After a predetermined time, the pressing cylinder 140 is operated to move the pressing plates 160 and 162 downwardly. That is, the non-woven fabric 370 mounted on the lower cap welding portion 352 is pressed by the pressing plates 160 and 162 to be bonded to the lower cap 350.

Next, the pressing cylinder 140 is operated to move the pressing plates 160 and 162 upwardly. The upper cap welding portion 362 of the upper cap 360 is melted on the upper cap mounting portions 290 and 292. The lower cap 350 boned with the non-woven fabric is mounted on the upper cap 360. Then, the pressing cylinder 240 is operated to move the pressing plates 260 and 262 downwardly and press the lower cap 350, so that the filter may be manufactured.

The filter manufacturing apparatus according to an embodiment of the present invention may be continuously manufactured by performing a process that mounts and melts two lower caps 350 and two upper caps 360 at the same time after the non-woven fabric 370 are bonded to two lower caps 350.

Referring to FIGS. 13 to 17, the non-woven fabric is bonded to the caps of the filter in a zigzag pattern. Bonding strength near a folded point is different from that near a straight-line area. However, since bonding strength near the folded point is strong enough, it is possible to get a strong and airtight bonding overall.

### INDUSTRIAL APPLICABILITY

The filter manufacturing apparatuses according to the present invention may melt only an inner portion of the upper cap or the lower cap by a melting plate which is heated by a heating plate with a hot wire, and press a non-woven fabric on the melted upper or lower cap with a predetermined pressure. Thereby, a strong and airtight filter can be manufactured in a short time by a simple process.

Also, smoke from the melting process is minimized, thereby improving work efficiency and productivity. Accordingly, a filter such as a fuel filter or an oil filter can be produced at a low cost.

1. A filter manufacturing apparatus with welding for fabricating a lower cap with an open upper portion and a lower cap welding portion therein, an upper cap with an open upper portion and an upper cap welding portion therein, and a non-woven fabric of a filter medium between the lower cap and the upper cap, comprising:
a lower cap heating unit for melting only the lower cap welding portion (352) by mounting the lower cap (350) and heating a hot wire connected to an external power supply;
a lower cap pressing unit for pressing the non-woven fabric (370) on the lower cap welding portion (352);
an upper cap heating unit for melting only the upper cap welding portion (362) by mounting the upper cap (360) and heating a hot wire connected to an external power supply; and
an upper cap pressing unit pressing the non-woven fabric (370) bonded to the lower cap (350) by the lower cap pressing unit on the upper cap welding portion (362).

2. The apparatus according to claim 1, further comprising:
a support plate (300) for supporting the lower and upper cap pressing units disposed on a front surface of the support plate (300) and the lower and upper cap heating units on a back surface of the support plate (300);
mounting supporters (180, 182, 280 and 282) respectively positioned under the lower cap pressing and heating units, and the upper cap pressing and heating units;
lower and upper cap mounting portions (190, 192, 290 and 292) mounted on the mounting supporters (180, 182, 280 and 282);
a first connection bar (184) connecting the mounting supporter (180) to the mounting supporter (182);
a second connection bar (284) connecting the mounting supporter (280) to the mounting supporter (282); and
moving cylinders (186 and 286) configured to be able to move the lower and upper cap mounting portions to the lower cap pressing and heating units and the upper cap pressing and heating units, the first and second connection bars being connected to a piston rod.

3. The apparatus according to claim 2, further comprising a lower cap fixing plate (194) with a circular plate shape and a plurality of protrusions at a side surface mounted on the lower cap mounting portions (190 and 192), so that the lower cap fixing plate (194) may be inserted into a mounting hole (354) of the lower cap (350).

4. The apparatus according to claim 2, wherein the lower and upper cap heating units comprises:
a heating unit frame (120) mounted on the supporting plate (300) in a rectangular shape;
a heating unit cylinder (100 and 200) mounted on an upper frame of the heating unit frame (120) at intervals of a predetermined distance;
movement limit plates (106 and 206) with a plate shape respectively mounted on the top side of piston rods (100 and 200) which move up and down in accordance with movement of the heating unit cylinders (100 and 200);
guide rods (104, 105, 204 and 205) mounted on both sides of the heating unit cylinders (100 and 200), vertically connected to the movement limit plates (106 and 206) at one side and penetrated into the heating unit frame (120) at the other side;
heating movement plates (174 and 274) with a plate shape connected to the piston rods (102 and 202) and the guide rods (104, 105, 204 and 205);
heating plates (170, 172, 270 and 272) respectively disposed at a lower side of the heating movement plates (174 and 274) with a hot wire generating heat of a predetermined temperature by receiving power from an external source; and
melting plates (171, 173, 271 and 273) respectively mounted on the lower surface of the heating plates (170, 172, 270 and 272).

5. The apparatus according to claim 4, wherein the melting plates (171, 173, 271 and 273) have a cylindrical shape with an open lower portion, and a side surface with a predetermined height so as to melt only the lower and upper cap welding portions (352 and 362), and are chamfered along a lower edge of the side thereof.

6. The apparatus according to claim 4, further comprising adhesion protectors (320 and 322) with a tuning fork shape disposed in the upper cap heating unit to prevent the upper cap (360) from moving together with melting plates (271 and 273) when the melting plates (271 and 273) move upwardly after melting the upper cap (360).

7. The apparatus according to claim 2, wherein the lower cap pressing unit comprises:
a lower cap pressing frame (130);
a pressing unit cylinder (140) mounted on the top side of the lower cap pressing frame (130);
a pressing movement plate (162) mounted on the top side of the lower cap pressing frame (130) connected to a piston rod of the pressing unit cylinder (140) and configured to be able to move up and down inside of the lower cap pressing frame (130);
pressing limit plates (150 and 152) mounted on a plurality of cylinders at the one end, the plurality of the cylinders being mounted on the top surface of the pressing movement plate (162) at the other end and penetrated into the top side of the lower cap pressing frame (130), so that the pressing movement (162) may move up and down in the lower cap pressing frame (130); and
pressing plates (160 and 162) mounted on the lower surface of the pressing movement plate (162) to press the non-woven fabric (370) and the lower cap (350) on the lower cap mounting portions (190 and 192).

8. The apparatus according to claim 2, wherein the upper cap pressing unit comprises:
an upper cap pressing frame (230);
a pressing unit cylinder (240) mounted on the top side of the upper cap pressing frame (230);
a pressing movement plate (262) mounted on the top side of the upper cap pressing frame (230) connected to a piston rod of the pressing unit cylinder (240) and configured to be able to move up and down inside of the upper cap pressing frame (230);
pressing limit plates (250 and 252) mounted on a plurality of cylinders at the one end, the plurality of the cylinders being mounted on the top surface of the pressing movement plate (262) at the other end and penetrated into the top side of the upper cap pressing frame (230), so that the pressing movement (262) may move up and down in the upper cap pressing frame (230); and
pressing plates (260 and 262) mounted on the lower surface of the pressing movement plate (262) to press the non-woven fabric (370) and the upper cap (360) on the upper cap mounting portions (290 and 292).
